(19) United States
(12) Patent Application Publication
(10) Pub. No.: US 2025/0081188 A1
(43) Pub. Date: Mar. 6, 2025

(54) UCI MULTIPLEXING FOR SIMULTANEOUS PUSCH TRANSMISSION

(71) Applicant: QUALCOMM Incorporated, San Diego, CA (US)

(72) Inventors: Mostafa KHOSHNEVISAN, San Diego, CA (US); Yitao CHEN, San Marcos, CA (US); Xiaoxia ZHANG, San Diego, CA (US); Jing SUN, San Diego, CA (US); Fang YUAN, Beijing (CN); Wooseok NAM, San Diego, CA (US); Tao LUO, San Diego, CA (US)

(21) Appl. No.: 18/681,027

(22) PCT Filed: Oct. 1, 2021
(86) PCT No.: PCT/CN2021/122487

§ 371 Date: Feb. 2, 2024

(51) Int. Cl. H04W 72/1268; H04B 7/06; H04L 27/26

(52) U.S. Cl. CPC H04W 72/1268; H04B 7/0626; H04L 27/261

(57) ABSTRACT

Method and apparatus for PUSCH selection for UCI multiplexing. The apparatus determines that a transmission of UCI would at least partially overlap in time with transmissions of a set of PUSCHs. The set of PUSCHs including a plurality of PUSCHs on a same CC that are at least partially overlapping in time. The apparatus selects one PUSCH of the set of PUSCHs for multiplexing the UCI. The selection of the one PUSCH being based at least partially on a group association between the UCI and each PUSCH of the set of PUSCHs, or one or more transmission parameters of each PUSCH of the plurality of PUSCHs. The apparatus multiplexes the UCI on the selected one PUSCH for simultaneous transmission.

### TECHNICAL FIELD

The present disclosure relates generally to communication systems, and more particularly, to a configuration for uplink control information (UCI) multiplexing for simultaneous physical uplink shared channel (PUSCH) transmission.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus determines that a transmission of uplink control information (UCI) would at least partially overlap in time with transmissions of a set of physical uplink shared channels (PUSCHs). The set of PUSCHs including a plurality of PUSCHs on a same component carrier (CC) that are at least partially overlapping in time. The apparatus selects one PUSCH of the set of PUSCHs for multiplexing the UCI. The selection of the one PUSCH being based at least partially on a group association between the UCI and each PUSCH of the set of PUSCHs, or one or more transmission parameters of each PUSCH of the plurality of PUSCHs. The apparatus multiplexes the UCI on the selected one PUSCH for simultaneous transmission.

In an aspect of the disclosure, a method, a computer-readable medium, and an apparatus are provided. The apparatus may be a device at a UE. The device may be a processor and/or a modem at a UE or the UE itself. The apparatus determines that a transmission of uplink control information (UCI) would at least partially overlap in time with transmissions of a set of physical uplink shared channels (PUSCHs). The set of PUSCHs including a plurality of PUSCHs on a same component carrier (CC) that are at least partially overlapping in time. The apparatus selects at least one PUSCH of the set of PUSCHs for multiplexing the UCI. The at least one PUSCH including a different number of PUSCHs based on application of a rule order. The apparatus multiplexes the UCI on each PUSCH of the selected at least one PUSCH for simultaneous transmission.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of multiplexing.

FIG. 5 is a diagram illustrating an example of multiplexing.

FIGS. 6A-6C are diagrams illustrating examples of multiplexing.

FIG. 7 is a diagram illustrating an example of multiplexing.

FIG. 8 is a call flow diagram of signaling between a UE and a base station.

FIG. 9 is a flowchart of a method of wireless communication.

FIG. 10 is a flowchart of a method of wireless communication.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

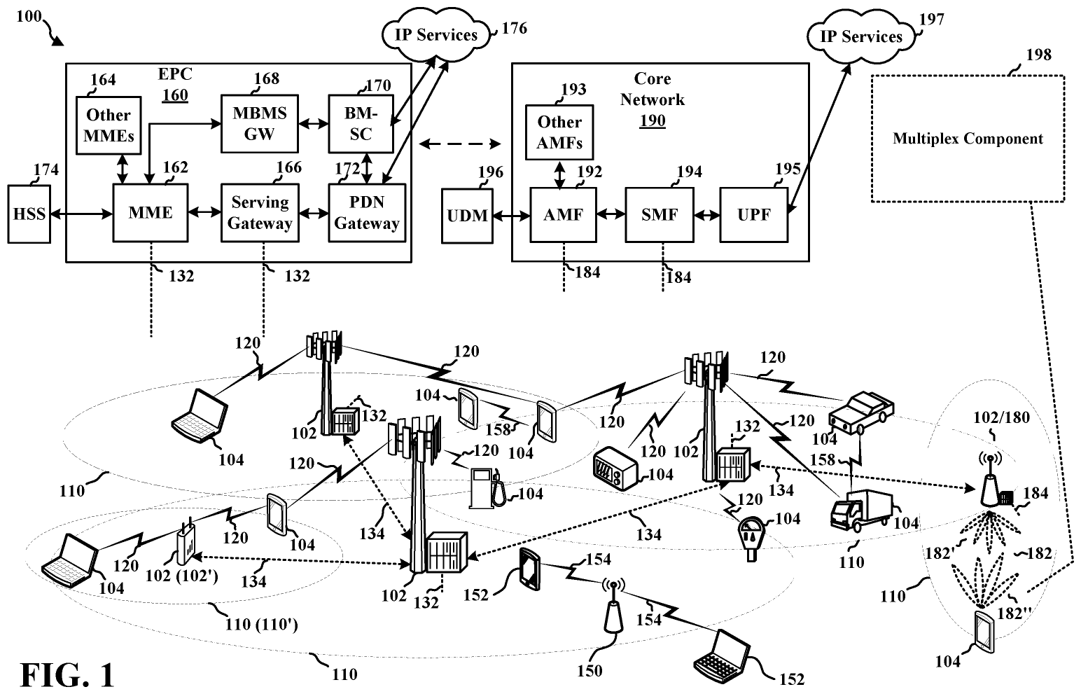

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to multiplex UCI based on an order when simultaneous PUSCH transmission is allowed in a CC. For example, the UE 104 may comprise a multiplex component 198 configured to multiplex UCI based on an order when simultaneous PUSCH transmission is allowed in a CC. The UE 104 may determine that a transmission of UCI would at least partially overlap in time with transmissions of a set of PUSCHs. The set of PUSCHs including a plurality of PUSCHs on a same CC that are at least partially overlapping in time. The UE 104 may select one PUSCH of the set of PUSCHs for multiplexing the UCI. The selection of the one PUSCH being based at least partially on a group association between the UCI and each PUSCH of the set of PUSCHs, or one or more transmission parameters of each PUSCH of the plurality of PUSCHs. The UE 104 may multiplex the UCI on the selected one PUSCH for simultaneous transmission.

Referring again to FIG. 1, in certain aspects, the UE 104 may be configured to multiplex UCI based on an order when simultaneous PUSCH transmission is allowed in a CC. For example, the UE 104 may comprise a multiplex component 198 configured to multiplex UCI based on an order when simultaneous PUSCH transmission is allowed in a CC. The UE 104 may determine that a transmission of UCI would at least partially overlap in time with transmissions of a set of PUSCHs. The set of PUSCHs including a plurality of PUSCHs on a same CC that are at least partially overlapping in time. The UE 104 may select at least one PUSCH of the set of PUSCHs for multiplexing the UCI. The at least one PUSCH including a different number of PUSCHs based on application of a rule order. The UE 104 may multiplex the UCI on each PUSCH of the selected at least one PUSCH for simultaneous transmission.

Although the following description may be focused on 5G NR, the concepts described herein may be applicable to other similar areas, such as LTE, LTE-A, CDMA, GSM, and other wireless technologies.

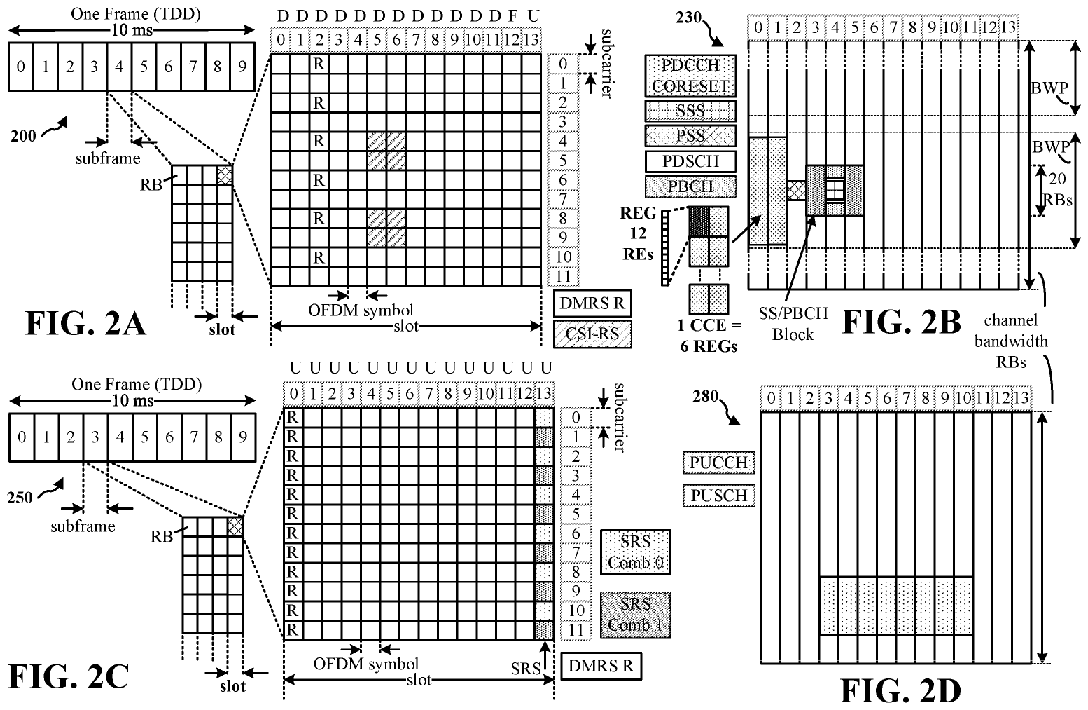

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

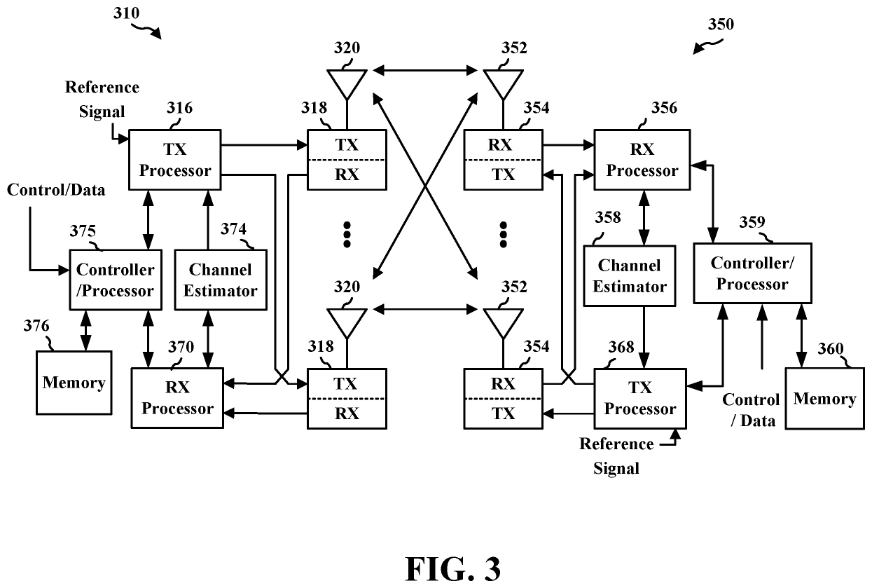

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

In wireless communications, certain multiplexing rules may be defined to resolve collisions (e.g., time overlap) between different uplink channels, such as for example, when PUSCH and PUCCH collide, or when PUCCH and PUCCH collide. The collision of PUCCH and PUCCH may comprise PUCCH for HARQ-ACK and PUCCH for scheduling request (SR), PUCCH for HARQ-ACK and PUCCH for channel state information (CSI), PUCCH for SR and PUCCH for CSI, PUCCH for HARQ-ACK and PUCCH for CSI plus PUCCH for SR. In these instances, assuming the joint timelines are satisfied, multiple UCI may be multiplexed on one PUCCH or on PUSCH. When one of the colliding channels comprises PUSCH, the UCI may be multiplexed on PUSCH. A beta offset may be signaled in an uplink grant (e.g., DCI format 0_1) or configured (e.g., RRC parameters) may be used to control the rate matching behavior for multiplexing PUCCH on PUSCH, for example, the number of resources that the UCI payload may occupy on PUSCH.

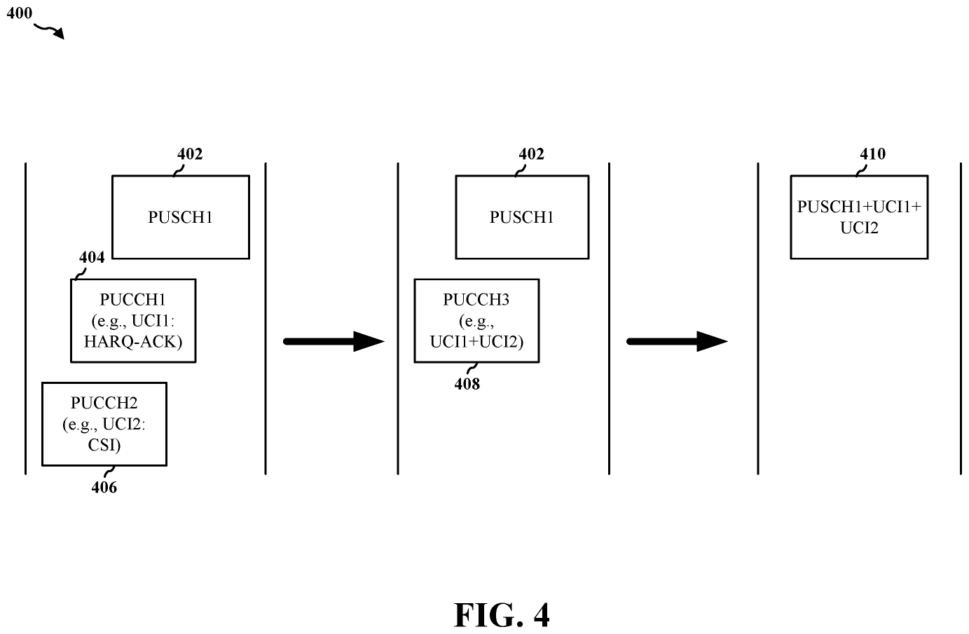

The general rule for multiplexing may include CSI being multiplexed on PUCCH if multiple CSI reports are in the slot, then HARQ-ACK/SR/CSI being multiplexed on PUCCH when they overlap in time, and then UCI may be multiplexed with PUSCH when they overlap in time. For example, with reference to diagram 400 of FIG. 4, a slot may include PUSCH1 402, PUCCH1 404, and PUCCH2 406. The PUCCH1 404 may comprise UCI1 corresponding to a HARQ-ACK. The PUCCH2 406 may comprise UCI2 corresponding to CSI. Based on the rule, PUCCH1 404 and PUCCH2 406 may be multiplexed to form PUCCH3 408. PUCCH1 404 and PUCCH2 406 overlap in time and may be multiplexed. PUCCH3 408 may be multiplexed with PUSCH1 402 to form PUSCH+UCI1+UCI2 410. PUCCH3 408 may be multiplexed with PUSCH1 402 due to the overlap in time.

In some wireless communication systems, for example NR, the following rule may be utilized when a UCI overlaps with more than one PUSCH in one or more uplink CCs. First, dynamic grant (DG) PUSCH(s) may be considered over configured grant (CG) PUSCH(s). If a UE transmits multiple PUSCHs in a slot on respective serving cells that include first PUSCHs that are scheduled by DCI formats and second PUSCHs configured by respective ConfiguredGrantConfig or semiPersistentOnPUSCH, and the UE would multiplex UCI in one of the multiple PUSCHs, and the multiple PUSCHs fulfill conditions for UCI multiplexing, then the UE may multiplex the UCI in a PUSCH from the first PUSCHs. Second, DG-PUSCH(s) with aperiodic CSI are considered for multiplexing. Third, the PUSCH on the smallest CC index among the multiple PUSCHs has priority. Fourth, the PUSCH that starts earlier may be considered, if multiple PUSCHs are in the CC with the smallest index. In one CC, PUSCHs may not be time domain overlapping. This condition is for instances where more than one PUSCH in a CC is transmitted in a time division multiplexed manner.

A UE may not expect a PUCCH resource that results from multiplexing overlapped PUCCH resources, if applicable, to overlap with more than one PUSCHs, if each of the more than one PUSCHs includes aperiodic CSI reports. If a UE transmits multiple PUSCHs in a slot on respective serving cells and the UE would multiplex UCI in one of the multiple PUSCHs and the UE does not multiplex aperiodic CSI in any of the multiple PUSCHs, the UE may multiplex the UCI in a PUSCH of the serving cell with the smallest ServCellIndex subject to the conditions for UCI multiplexing being fulfilled. If the UE transmits more than one PUSCH in the slot on the serving cell with the smallest ServCellIndex that fulfills the conditions for UCI multiplexing, then the UE may multiplex the UCI in the earliest PUSCH that the UE transmits in the slot.

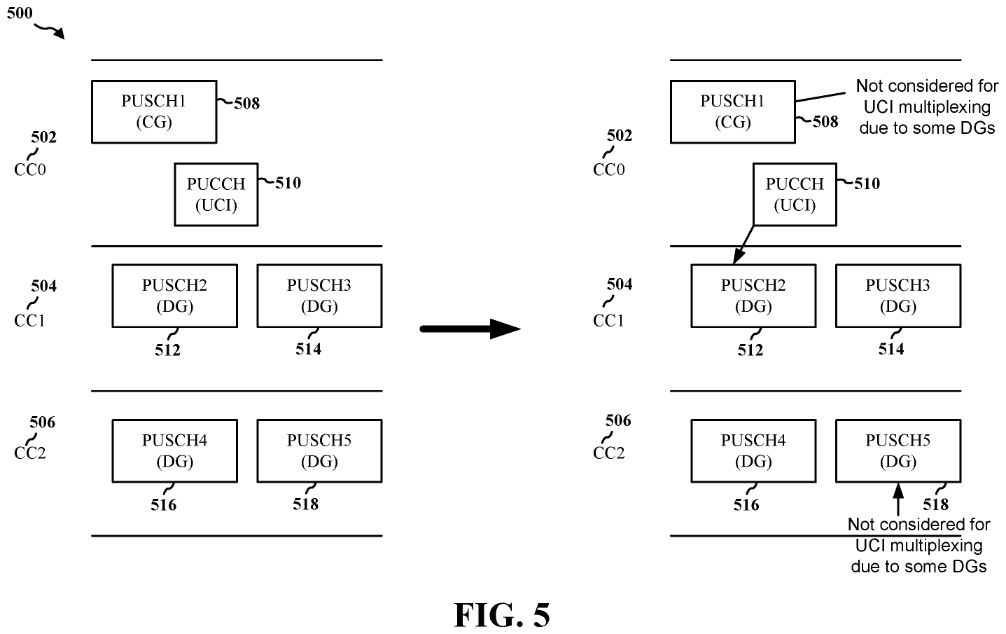

FIG. 5 is a diagram 500 of a multiplexing operation. The diagram 500 includes a first CC index CC0 502, a second CC index CC1 504, and a third CC index CC2 506. The CC0 502 may include a CG PUSCH1 508 and a PUCCH 510 carrying UCI. The CC1 504 may include a DG PUSCH2 512 and a DG PUSCH3 514. The CC2 506 may include a DG PUSCH4 516 and a DG PUSCH5 518. Based on the rule, the PUCCH 510 may be multiplexed with PUSCH2 512 based on the PUSCH2 having the lowest CC index among DGs without aperiodic CSI, and based on PUSCH2 512 starting earlier in time than PUSCH3 514. The CG PUSCH1 508 is not considered for UCI multiplexing due in part to DG PUSCHs being present, thereby having priority over a CG-PUSCH. In addition, CG PUSCH5 518 is not considered for UCI multiplexing due in part to DG PUSCHs being present. DG PUSCH3 514 and DG PUSCH4 516 may be considered for UCI multiplexing, but DG PUSCH2 512 has the lowest CC index and has priority over DG PUSCH4 516 having a higher CC index, and starts earlier in time than DG PUSCH3, despite both having the same CC index.

Two PUSCHs in the same CC that are overlapping in time may not be transmitted simultaneously. Simultaneous PUSCH transmissions in the time domain in one CC may occur in certain instances. For example, if transmissions are from different UE panels (e.g., in FR2) or from different antenna ports. Restrictions may apply such as two PUSCHs may be transmitted simultaneously if the two PUSCHs are associated with different groups. Within a group, simultaneous PUSCH transmission may not be allowed. If there are two groups, the maximum number of simultaneous PUSCH transmission is two. Different ways may be based on which association of a PUSCH with a group can be defined: CORESET group (CORESETPoolIndex), UE panel, UL beam group, SRS resource set, or DMRS CDM group. CORESETPoolIndex may be the most natural notion of group in this case. For DG, may be determined from the CORESET in which the DCI scheduling the PUSCH is transmitted. For CG, may be determined from the CORESET in which the activation DCI is transmitted, or may be determined based on RRC configuration of the CG-Config.

Aspects presented herein provide a configuration for UCI multiplexing order when simultaneous PUSCH transmission is allowed in a CC. For example, if a UE transmits multiple (e.g., two or more) PUSCHs in a slot on respective CCs (e.g., one or more) and the UE would multiplex UCI in one of the multiple PUSCHs, such that the UCI overlaps with the multiple PUSCHs, and at least in one CC two time domain overlapping PUSCHs are transmitted, then the UE may multiplex the UCI in a PUSCH among the multiple PUSCHs. The UE may multiplex the UCI in the PUSCH among the multiple PUSCHs based at least in part on the two-time domain overlapping PUSCHs in the at least one CC.

In some instances, each PUSCH may be associated with a group among two or more groups. The association of a PUSCH with a group may be defined based on at least one of a CORESET group (e.g., CORESETPoolIndex), UE panel identifier (ID), uplink beam group, SRS resource set, DMRS CDM group, or priority. In instances where a PUSCH does not have an explicit group association, the PUSCH may be assumed to be associated with a fixed or first group. If two PUSCHs are transmitted simultaneously in a CC, then the two PUSCHs may be associated with different groups. The UCI may be associated with one of the two groups, or may be assumed to be associated with a fixed or first group. In some instances, there may be no such groupings of PUSCHs.

In some instances, if there are two PUSCHs both overlapping with the UCI and are associated with different groups, the PUSCH that is associated with the same group as the UCI is associated with may be selected for multiplexing. This rule related to the same grouping may be applied at different levels to provide multiple rule orders. For example, a first rule order may comprise (1) PUSCHs in a same group as the UCI have priority for selection, (2) PUSCHs configured through DG have priority for selection over PUSCHs configured through CG, (3) PUSCHs that include aperiodic CSI have priority for selection, (4) PUSCHs with lower CC indexes have priority for selection, and (5) PUSCHs with an earlier start time have priority for selection.

In another example, a second rule order may comprise (1) PUSCHs configured through DG have priority for selection over PUSCHs configured through CG, (2) PUSCHs in a same group as the UCI have priority for selection, (3) PUSCHs that include aperiodic CSI have priority for selection, (4) PUSCHs with lower CC indexes have priority for selection, and (5) PUSCHs with an earlier start time have priority for selection.

In another example, a third rule order may comprise (1) PUSCHs configured through DG have priority for selection over PUSCHs configured through CG, (2) PUSCHs that include aperiodic CSI have priority for selection, (3) PUSCHs in a same group as the UCI have priority for selection, (4) PUSCHs with lower CC indexes have priority for selection, and (5) PUSCHs with an earlier start time have priority for selection.

In another example, a fourth rule order may comprise (1) PUSCHs configured through DG have priority for selection over PUSCHs configured through CG, (2) PUSCHs that include aperiodic CSI have priority for selection, (3) PUSCHs with lower CC indexes have priority for selection, (4) PUSCHs in a same group as the UCI have priority for selection, and (5) PUSCHs with an earlier start time have priority for selection.

In yet another example, a fifth rule order may comprise (1) PUSCHs configured through DG have priority for selection over PUSCHs configured through CG, (2) PUSCHs that include aperiodic CSI have priority for selection, (3) PUSCHs with lower CC indexes have priority for selection, (4) PUSCHs with an earlier start time have priority for selection, and (5) PUSCHs in a same group as the UCI have priority for selection.

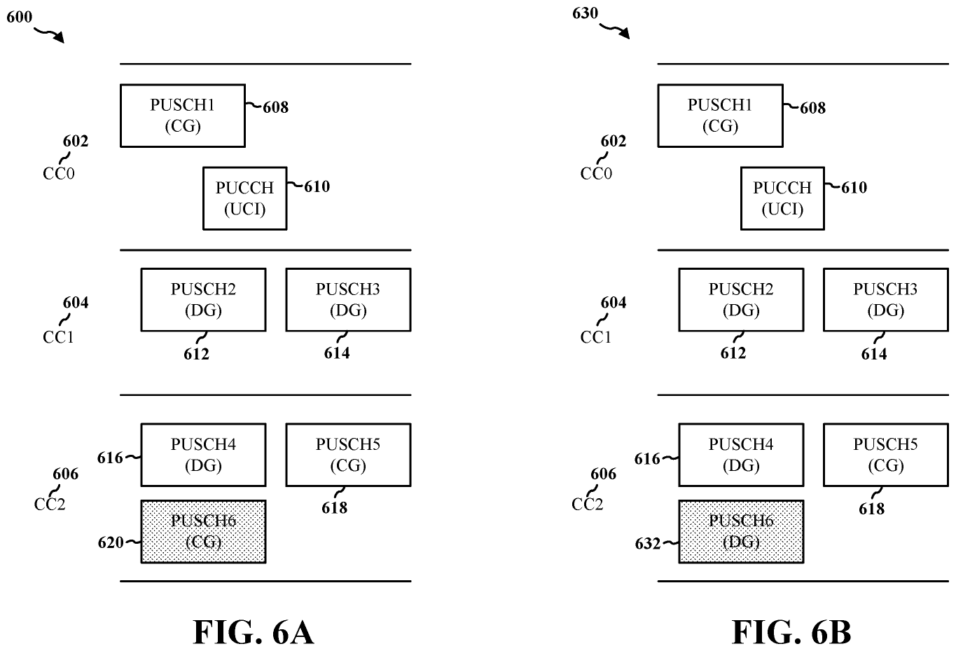

FIGS. 6A-6C are diagrams 600, 630, 640 of UCI multiplexing configurations. Diagram 600 of FIG. 6A includes CC indexes CC0 602, CC1 604, and CC2 606. CC0 602 may include CG PUSCH1 608 and PUCCH 610 having UCI. CC1 604 may include DG PUSCH2 612 and DG PUSCH3 614. CC2 606 may include DG PUSCH4 616, CG PUSCH5 618, and CG PUSCH6 620. PUSCH6 may be associated with a first group (e.g., group0) while PUSCH1-5 may be associated with a second group (e.g., group1). The UCI within PUCCH 610 may be associated with the first group group0 or may not be explicitly associated with group0. However, for UCI multiplexing a fixed group being group0 may be considered. Based on the application of the first rule order, the PUSCH that may be selected for multiplexing with the UCI may comprise PUSCH6 620. PUSCH6 620 may be selected for multiplexing with the UCI based on the first rule order due to both the PUSCH6 620 and the UCI within PUCCH 610 being associated with the same group. Based on the application of the second rule order, the PUSCH that may be selected for multiplexing with the UCI may comprise PUSCH2 612. PUSCH2 612 may be selected based on the second rule order due to DG PUSCH having priority over CG PUSCH, PUSCH2 612 has the lowest CC index (e.g., CC1 604), and starts the earliest. In fact, in the example 600 of FIG. 6A, application of rule orders (3)-(5) also results in PUSCH2 612 being selected for multiplexing with the UCI of PUCCH 610, despite PUSCH2 612 and the UCI of PUCCH 610 being in different groups.

The diagram 630 of FIG. 6B provides another example of a UCI multiplexing configuration. Diagram 630 of FIG. 6B includes a PUSCH1-5 and a PUCCH 610 having a UCI, similar as in the diagram 600 of FIG. 6A. However, diagram 630 further includes a DG PUSCH6 632. The PUSCH6 632 may be associated with a first group (e.g., group0) while PUSCH1-5 may be associated with a second group (e.g., group1). The UCI within PUCCH 610 may be associated with the first group group0 or may not be explicitly associated with group0. Based on the application of the first, second, and third rule order, the PUSCH that may be selected for multiplexing with the UCI may comprise PUSCH6 632. PUSCH6 632 may be selected for multiplexing with the UCI due to both being associated with the same group, which has the highest level of priority in the first rule order. PUSCH6 632 may be selected for multiplexing with the UCI due to PUSCH6 632 being a DG PUSCH, which has the highest level of priority in the second and third rule order, while both also being associated with the same group factors into the decision. However, application of the fourth and fifth rule order result in PUSCH2 612 being selected for multiplexing with the UCI, due to PUSCH2 612 having a lower CC index (e.g., CC1 604) than that of PUSCH6.

The diagram 640 of FIG. 6C provides yet another example of a UCI multiplexing configuration. Diagram 640 of FIG. 6C includes a PUSCH1-5 and a PUCCH 610 having a UCI, similar as in the diagrams 600 of FIG. 6A and 630 of FIG. 6B. However, diagram 640 further includes a DG PUSCH6 642 that is within CC1 604. The PUSCH6 642 may be associated with a first group (e.g., group0) while PUSCH1-5 may be associated with a second group (e.g., group1). The UCI within PUCCH 610 may be associated with the first group group0 or may not be explicitly associated with group0. Based on the application of the first, second, third, and fourth rule order, the PUSCH that may be selected for multiplexing with the UCI may comprise PUSCH6 642. PUSCH6 642 may be selected for multiplexing with the UCI due to both being associated with the same group, which has the highest level of priority in the first rule order. While PUSCH2, PUSCH3, and PUSCH6 are each DG PUSCHs, the application of the first step of the second, third, and fourth rule order results in a tie. In the second rule order, the next step is the grouping, and PUSCH6 642 and UCI are associated with the same group (e.g., group0) such that PUSCH6 642 is selected for multiplexing with the UCI in the second rule order. In the third rule order, the next step is to check if one of the PUSCHs include aperiodic CSI, and it can be assumed that none of the PUSCHs in diagram 640 have aperiodic CSI, such that the next step is examined, which is directed to the grouping, and PUSCH6 642 and UCI are associated with the same group (e.g., group0) such that PUSCH6 642 is selected for multiplexing with the UCI in the third rule order. In the fourth rule order, the step the follows the step of checking if one of the PUSCHs include aperiodic CSI is directed to PUSCHs having the lowest CC index. However, PUSCH2, PUSCH3, and PUSCH6 are in the same index, and PUSCH1 608 is within a lower CC index, but is a CG PUSCH and PUSCH2, PUSCH3, and PUSCH6 are DG PUSCHs and thus have priority over PUSCH1. Thus, the next step of the fourth rule order is examined which is related to the grouping, and this results in PUSCH6 being selected for multiplexing with the UCI. In application of the fifth rule order results in the selection of PUSCH2 612 because PUSCH2 612 starts the earliest of the DG PUSCHs within CC1.

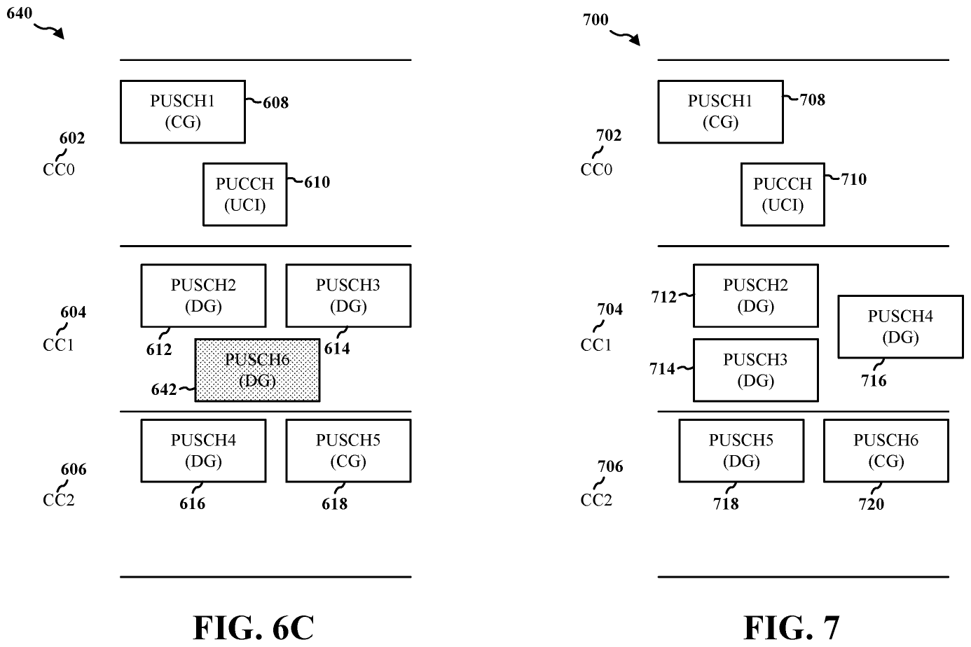

FIG. 7 is a diagram 700 of a UCI multiplexing configuration. Diagram 700 of FIG. 7 includes CC indexes CC0 702, CC1 704, CC2 706. CC0 702 may include CG PUSCH1 708 and PUCCH 710 having UCI. CC1 704 may include DG PUSCH2 712, DG PUSCH3 714, and DG PUSCH4 716. CC2 706 may include DG PUSCH5 718 and CG PUSCH6 720. In the diagram 700 there are no groupings of the PUSCHs. The order rule for instances where there are no groupings may comprise (1) PUSCHs configured through DG having priority over PUSCHs configured through CG, (2) PUSCHs that include aperiodic CSI have priority for selection, (3) PUSCHs with a lower CC index have priority for selection, and (4) PUSCHs with the earliest start time have priority.

In some instances, if two PUSCHs are in the lowest CC index and start at the same time, then selection of the PUSCH may be based at least partially on one or more transmission parameters of the PUSCHs, such that the rule order further includes (5) one or more transmission parameters of the PUSCHs. The one or more transmission parameters of each PUSCH that may be considered comprises at least one of a starting RB index associated with a frequency domain resource allocation of the PUSCH, a modulation and coding scheme (MCS) for the PUSCH, whether the PUSCH is an initial transmission or a retransmission, a resource allocation in time and frequency for the PUSCH, a number of layers in the PUSCH, a CG index of the PUSCH, whether the PUSCH has a same beam as a PUCCH resource on which the UCI was originally scheduled, or a transmission power associated with the PUSCH. The rule (5) may be applied for selecting the PUSCH for multiplexing the UCI after application of rules (1)-(4), where the PUSCH may be selected based on at least one of whether the one PUSCH has a lowest starting RB index of the plurality of PUSCHs, whether the one PUSCH has a lowest MCS or a highest MCS of the plurality of PUSCHs, whether the one PUSCH corresponds to an initial transmission or a retransmission of the plurality of PUSCHs, whether the one PUSCH has a larger resource allocation in time and frequency of the plurality of PUSCHs, whether the one PUSCH has a larger number of layers or a smaller number of layers of the plurality of PUSCHs, whether the one PUSCH has a lower CG index of the plurality of PUSCHs, whether the one PUSCH is to be transmitted on a same beam as the PUCCH resource on which the UCI was originally scheduled, or whether the one PUSCH has a larger transmission power of the plurality of PUSCHs. In the application of rules (1)-(4) in the diagram 700, PUSCH2 712 and PUSCH3 714 meet the conditions of rules (1)-(4), such that the application of rule (5) may be used to determine the selection between PUSCH2 712 and PUSCH3 714.

In some aspects, if after the application of rules (1)-(4) there are two PUSCHs in the lowest CC index and start at the same time, the transmission parameters may not be considered. Instead, in such instances, the UCI may be multiplexed on both PUSCHs. In such instances, the UCI may be multiplexed with each of PUSCH2 712 and PUSCH3 714, due to both PUSCH2 712 and PUSCH3 714 being in the lowest index (e.g., CC1) and starting at the same time.

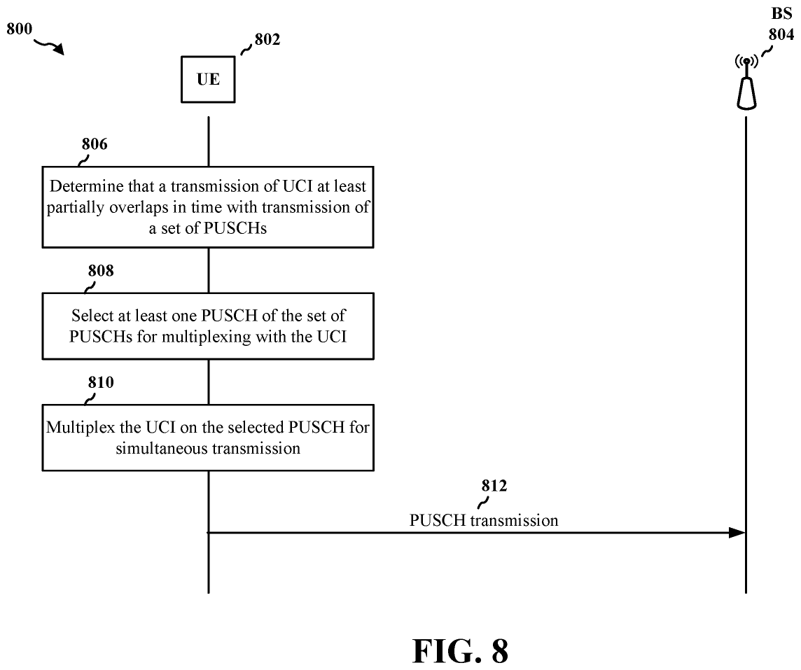

FIG. 8 is a call flow diagram 800 of signaling between a UE 802 and a base station 804. The base station 804 may be configured to provide at least one cell. The UE 802 may be configured to communicate with the base station 804. For example, in the context of FIG. 1, the base station 804 may correspond to base station 102/180 and, accordingly, the cell may include a geographic coverage area 110 in which communication coverage is provided and/or small cell 102′ having a coverage area 110′. Further, a UE 802 may correspond to at least UE 104. In another example, in the context of FIG. 3, the base station 804 may correspond to base station 310 and the UE 802 may correspond to UE 350.

At 806, the UE 802 may determine that a transmission of UCI would at least partially overlap in time with transmissions of a set of PUSCHs. The set of PUSCHs may include a plurality of PUSCHs on a same component carrier (CC) that are at least partially overlapping in time.

At 808, the UE 802 may select at least one PUSCH of the set of PUSCHs for multiplexing with the UCI. For example, the UE may select one PUSCH of the set of PUSCHs for multiplexing the UCI. The selection of the one PUSCH may be based at least partially on a group association between the UCI and each PUSCH of the set of PUSCHs, or one or more transmission parameters of each PUSCH of the plurality of PUSCHs. In some aspects, the selection of the one PUSCH may be based at least partially on the group association between the UCI and each PUSCH of the set of PUSCHs. The selection of the one PUSCH may be based at least partially on whether the one PUSCH is in a same group as the UCI. In some aspects, each group may be defined based on an association of the UCI and the PUSCH with at least one of a CORESET group, a UE panel ID, an UL beam group, an SRS resource set, a demodulation reference signal (DMRS) code division multiplex (CDM) group, or a priority.

In some aspects, the selection of the one PUSCH of the set of PUSCHs for multiplexing the UCI may be based on a rule order. In some aspects, the rule order may comprise (1) PUSCHs in a same group as the UCI have priority for selection, (2) PUSCHs configured through DGs having priority for selection over PUSCHs configured through CGs, (3) PUSCHs that include aperiodic (AP) channel state information (CSI) (AP-CSI) have priority for selection, (4) PUSCHs with lower CC indexes having priority for selection, and (5) PUSCHs with an earlier start time having priority for selection. In some aspects, the rule order may comprise (1) PUSCHs configured through DGs have priority for selection over PUSCHs configured through CGs, (2) PUSCHs in a same group as the UCI have priority for selection, (3) PUSCHs that include AP-CSI have priority for selection, (4) PUSCHs with lower CC indexes have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs in a same group as the UCI have priority for selection, (4) PUSCHs with lower CC indexes have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs in a same group as the UCI have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs with an earlier start time have priority for selection, and (5) PUSCHs in a same group as the UCI have priority for selection.

In some aspects, the selection of the one PUSCH may be based at least partially on the one or more transmission parameters of each PUSCH of the plurality of PUSCHs. The one or more transmission parameters of each PUSCH of the plurality of PUSCHs may comprise at least one of a starting RB index associated with a frequency domain resource allocation of the PUSCH, an MCS for the PUSCH, whether the PUSCH is an initial transmission or a retransmission, a resource allocation in time and frequency for the PUSCH, a number of layers in the PUSCH, a CG index of the PUSCH, whether the PUSCH has a same beam as a PUCCH resource on which the UCI was originally scheduled, or a transmission power associated with the PUSCH. The selection of the one PUSCH may be based at least partially on the one or more transmission parameters of the one PUSCH. In some aspects, the selection of the one PUSCH for multiplexing the UCI may be based on a rule order. In some aspects, the rule order may comprise (1) PUSCHs configured through DGs having priority for selection over PUSCHs configured through CGs, (2) PUSCHs that include AP-CSI have priority for selection, (3) PUSCHs with lower CC indexes having priority for selection, (4) PUSCHs with an earlier start time having priority for selection, and (5) the one or more transmission parameters. In instances when rule (5) is applied for selecting the one PUSCH for multiplexing the UCI after application of rules (1)-(4), the one PUSCH may be selected based on at least one of whether the one PUSCH has a lowest starting RB index of the plurality of PUSCHs; whether the one PUSCH has a lowest MCS or a highest MCS of the plurality of PUSCHs; whether the one PUSCH corresponds to an initial transmission or a retransmission of the plurality of PUSCHs; whether the one PUSCH has a larger resource allocation in time and frequency of the plurality of PUSCHs; whether the one PUSCH has a larger number of layers or a smaller number of layers of the plurality of PUSCHs; whether the one PUSCH has a lower CG index of the plurality of PUSCHs; whether the one PUSCH is to be transmitted on a same beam as the PUCCH resource on which the UCI was originally scheduled; or whether the one PUSCH has a larger transmission power of the plurality of PUSCHs.

In another example, the UE may select at least one PUSCH of the set of PUSCHs for multiplexing the UCI. The at least one PUSCH may include a different number of PUSCHs based on application of a rule order. In some aspects, the rule order may comprise (1) PUSCHs configured through DGs having priority for selection over PUSCHs configured through CGs, (2) PUSCHs that include AP-CSI have priority for selection, (3) PUSCHs with lower CC indexes having priority for selection, and (4) PUSCHs with an earlier start time having priority for selection. In some aspects, the at least one PUSCH may comprise the plurality of PUSCHs when the plurality of PUSCHs have a same start time and, after application of rules (1)-(4), the plurality of PUSCHs remain for selection.

At 810, the UE 802 may multiplex the UCI on the selected PUSCH for transmission. For example, the UE may multiplex the UCI on the selected one PUCCH. The UE may multiplex the UCI on the selected one PUCCH for transmission. In another example, the UE may multiplex the UCI on each PUSCH of the selected at least one PUSCH. The UE may multiplex the UCI on each PUSCH of the selected at least one PUSCH for simultaneous transmission.

At 812, the UE may transmit the PUSCH to the base station 804. The base station 804 may receive the PUSCH transmitted by the UE.

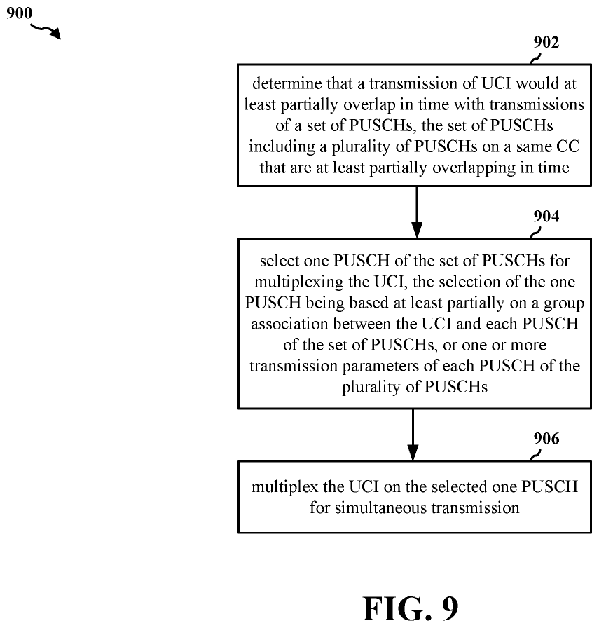

FIG. 9 is a flowchart 900 of a method of wireless communication. The method may be performed by a UE or a component of a UE (e.g., the UE 104; the apparatus 1102; the cellular baseband processor 1104, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to multiplex UCI based on an order when simultaneous PUSCH transmission is allowed in a CC.

At 902, the UE may determine that a transmission of UCI would at least partially overlap in time with transmissions of a set of PUSCHs. For example, 902 may be performed by determination component 1140 of apparatus 1102. The set of PUSCHs may include a plurality of PUSCHs on a same CC that are at least partially overlapping in time.

At 904, the UE may select one PUSCH of the set of PUSCHs for multiplexing the UCI. For example, 904 may be performed by selection component 1142 of apparatus 1102. The selection of the one PUSCH may be based at least partially on a group association between the UCI and each PUSCH of the set of PUSCHs, or one or more transmission parameters of each PUSCH of the plurality of PUSCHs. In some aspects, the selection of the one PUSCH may be based at least partially on the group association between the UCI and each PUSCH of the set of PUSCHs. The selection of the one PUSCH may be based at least partially on whether the one PUSCH is in a same group as the UCI. In some aspects, each group may be defined based on an association of the UCI and the PUSCH with at least one of a CORESET group, a UE panel ID, an UL beam group, a SRS resource set, a DMRS CDM group, or a priority.

In some aspects, the selection of the one PUSCH of the set of PUSCHs for multiplexing the UCI may be based on a rule order. In some aspects, the rule order may comprise (1) PUSCHs in a same group as the UCI have priority for selection, (2) PUSCHs configured through DGs having priority for selection over PUSCHs configured through CGs, (3) PUSCHs that include AP-CSI have priority for selection, (4) PUSCHs with lower CC indexes having priority for selection, and (5) PUSCHs with an earlier start time having priority for selection. In some aspects, the rule order may comprise (1) PUSCHs configured through DGs have priority for selection over PUSCHs configured through CGs, (2) PUSCHs in a same group as the UCI have priority for selection, (3) PUSCHs that include AP-CSI have priority for selection, (4) PUSCHs with lower CC indexes have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs in a same group as the UCI have priority for selection, (4) PUSCHs with lower CC indexes have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs in a same group as the UCI have priority for selection, and (5) PUSCHs with an earlier start time have priority for selection. In some aspects, the rule order may comprise (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs with an earlier start time have priority for selection, and (5) PUSCHs in a same group as the UCI have priority for selection.

In some aspects, the selection of the one PUSCH may be based at least partially on the one or more transmission parameters of each PUSCH of the plurality of PUSCHs. The one or more transmission parameters of each PUSCH of the plurality of PUSCHs may comprise at least one of a starting RB index associated with a frequency domain resource allocation of the PUSCH, a MCS for the PUSCH, whether the PUSCH is an initial transmission or a retransmission, a resource allocation in time and frequency for the PUSCH, a number of layers in the PUSCH, a CG index of the PUSCH, whether the PUSCH has a same beam as a PUCCH resource on which the UCI was originally scheduled, or a transmission power associated with the PUSCH. The selection of the one PUSCH may be based at least partially on the one or more transmission parameters of the one PUSCH. In some aspects, the selection of the one PUSCH for multiplexing the UCI may be based on a rule order. In some aspects, the rule order may comprise (1) PUSCHs configured through DGs having priority for selection over PUSCHs configured through CGs, (2) PUSCHs that include AP-CSI have priority for selection, (3) PUSCHs with lower CC indexes having priority for selection, (4) PUSCHs with an earlier start time having priority for selection, and (5) the one or more transmission parameters. In instances when rule (5) is applied for selecting the one PUSCH for multiplexing the UCI after application of rules (1)-(4), the one PUSCH may be selected based on at least one of whether the one PUSCH has a lowest starting RB index of the plurality of PUSCHs; whether the one PUSCH has a lowest MCS or a highest MCS of the plurality of PUSCHs; whether the one PUSCH corresponds to an initial transmission or a retransmission of the plurality of PUSCHs; whether the one PUSCH has a larger resource allocation in time and frequency of the plurality of PUSCHs; whether the one PUSCH has a larger number of layers or a smaller number of layers of the plurality of PUSCHs; whether the one PUSCH has a lower CG index of the plurality of PUSCHs; whether the one PUSCH is to be transmitted on a same beam as the PUCCH resource on which the UCI was originally scheduled; or whether the one PUSCH has a larger transmission power of the plurality of PUSCHs.

At 906, the UE may multiplex the UCI on the selected one PUCCH. For example, 906 may be performed by multiplex component 1144 of apparatus 1102. The UE may multiplex the UCI on the selected one PUCCH for simultaneous transmission.

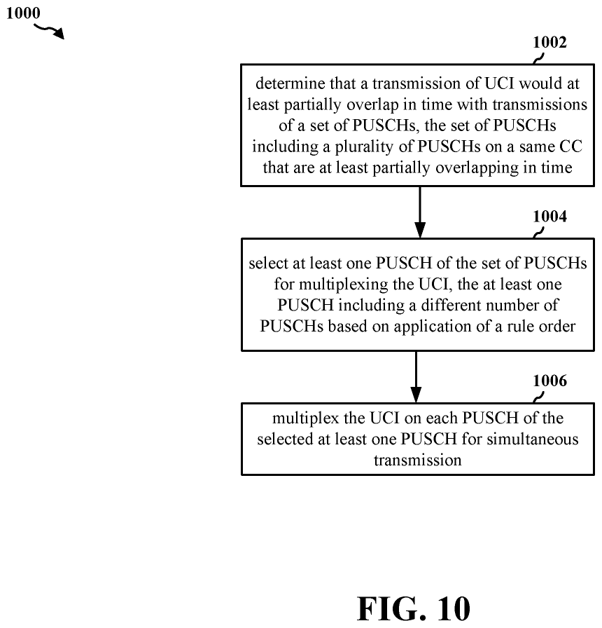

FIG. 10 is a flowchart 1000 of a method of wireless communication. The method may be performed by a UE or a component of a UE (e.g., the UE 104; the apparatus 1102; the cellular baseband processor 1104, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to multiplex UCI based on an order when simultaneous PUSCH transmission is allowed in a CC.

At 1002, the UE may determine that a transmission of UCI would at least partially overlap in time with transmissions of a set of PUSCHs. For example, 1002 may be performed by determination component 1140 of apparatus 1102. The set of PUSCHs including a plurality of PUSCHs on a same CC that are at least partially overlapping in time.

At 1004, the UE may select at least one PUSCH of the set of PUSCHs for multiplexing the UCI. For example, 1004 may be performed by selection component 1142 of apparatus 1102. The at least one PUSCH may include a different number of PUSCHs based on application of a rule order. In some aspects, the rule order may comprise (1) PUSCHs configured through DGs having priority for selection over PUSCHs configured through CGs, (2) PUSCHs that include AP-CSI have priority for selection, (3) PUSCHs with lower CC indexes having priority for selection, and (4) PUSCHs with an earlier start time having priority for selection. In some aspects, the at least one PUSCH may comprise the plurality of PUSCHs when the plurality of PUSCHs have a same start time and, after application of rules (1)-(4), the plurality of PUSCHs remain for selection.

At 1006, the UE may multiplex the UCI on each PUSCH of the selected at least one PUSCH. For example, 1006 may be performed by multiplex component 1144 of apparatus 1102. The UE may multiplex the UCI on each PUSCH of the selected at least one PUSCH for simultaneous transmission.

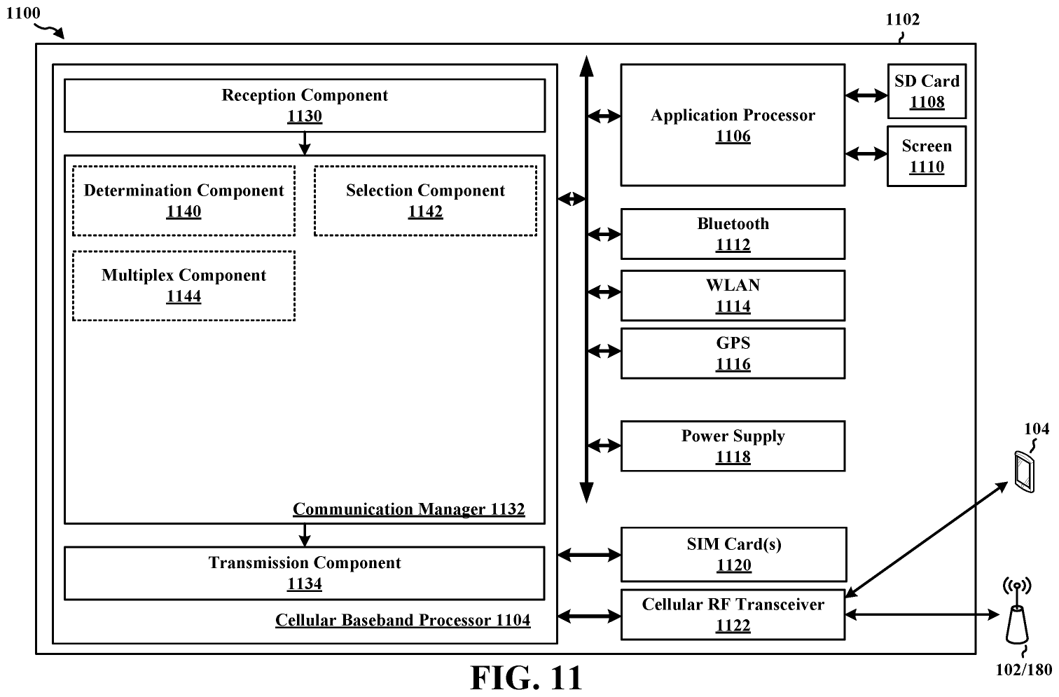

FIG. 11 is a diagram 1100 illustrating an example of a hardware implementation for an apparatus 1102. The apparatus 1102 may be a UE, a component of a UE, or may implement UE functionality. In some aspects, the apparatus 1102 may include a cellular baseband processor 1104 (also referred to as a modem) coupled to a cellular RF transceiver 1122. In some aspects, the apparatus 1102 may further include one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, or a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the additional modules of the apparatus 1102.

The communication manager 1132 includes a determination component 1140 that is configured to determine that a transmission of UCI would at least partially overlap in time with transmissions of a set of PUSCHs, e.g., as described in connection with 902 of FIG. 9 or 1002 of FIG. 10. The communication manager 1132 further includes a selection component 1142 that is configured to select one PUSCH of the set of PUSCHs for multiplexing the UCI, e.g., as described in connection with 904 of FIG. 9. The selection component 1142 may be further configured to select at least one PUSCH of the set of PUSCHs for multiplexing the UCI, e.g., as described in connection with 1004 of FIG. 10. The communication manager 1132 further includes a multiplex component 1144 that is configured to multiplex the UCI on the selected one PUCCH, e.g., as described in connection with 906 of FIG. 9. The multiplex component 1144 may be further configured to multiplex the UCI on each PUSCH of the selected at least one PUSCH, e.g., as described in connection with 1006 of FIG. 10.

The apparatus may include additional components that perform each of the blocks of the algorithm in the flowcharts of FIGS. 9 and 10. As such, each block in the flowcharts of FIGS. 9 and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the cellular baseband processor 1104, includes means for determining that a transmission of UCI would at least partially overlap in time with transmissions of a set of PUSCHs. The set of PUSCHs including a plurality of PUSCHs on a same CC that are at least partially overlapping in time. The apparatus includes means for selecting one PUSCH of the set of PUSCHs for multiplexing the UCI. The selection of the one PUSCH being based at least partially on a group association between the UCI and each PUSCH of the set of PUSCHs, or one or more transmission parameters of each PUSCH of the plurality of PUSCHs. The apparatus includes means for selecting at least one PUSCH of the set of PUSCHs for multiplexing the UCI. The at least one PUSCH including a different number of PUSCHs based on application of a rule order. The apparatus includes means for multiplexing the UCI on the selected one PUSCH for transmission. The apparatus includes means for multiplexing the UCI on each PUSCH of the selected at least one PUSCH for transmission. The means may be one or more of the components of the apparatus 1102 configured to perform the functions recited by the means. As described supra, the apparatus 1102 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to determine that a transmission of UCI would at least partially overlap in time with transmissions of a set of PUSCHs, the set of PUSCHs including a plurality of PUSCHs on a same CC that are at least partially overlapping in time; select one PUSCH of the set of PUSCHs for multiplexing the UCI, the selection of the one PUSCH being based at least partially on a group association between the UCI and each PUSCH of the set of PUSCHs, or one or more transmission parameters of each PUSCH of the plurality of PUSCHs; and multiplex the UCI on the selected one PUSCH for simultaneous transmission.

Aspect 2 is the apparatus of aspect 1, further including a transceiver coupled to the at least one processor.

Aspect 3 is the apparatus of any of aspects 1 and 2, further includes that the selection of the one PUSCH is based at least partially on the group association between the UCI and each PUSCH of the set of PUSCHs, and the selection of the one PUSCH is based at least partially on whether the one PUSCH is in a same group as the UCI.

Aspect 4 is the apparatus of any of aspects 1-3, further includes that each group is defined based on an association of the UCI and the PUSCH with at least one of a CORESET group, a UE panel ID, a UL beam group, an SRS resource set, a DMRS CDM group, or a priority.

Aspect 5 is the apparatus of any of aspects 1-4, further includes that the selection of the one PUSCH of the set of PUSCHs for multiplexing the UCI is based on a rule order.

Aspect 6 is the apparatus of any of aspects 1-5, further includes that the rule order comprises (1) PUSCHs in a same group as the UCI have priority for selection, (2) PUSCHs configured through DGs have priority for selection over PUSCHs configured through CGs, (3) PUSCHs that include AP-CSI have priority for selection, (4) PUSCHs with lower CC indexes have priority for selection, and (5) PUSCHs with an earlier start time have priority for selection.

Aspect 7 is the apparatus of any of aspect 1-6, further includes that the rule order comprises (1) PUSCHs configured through DGs have priority for selection over PUSCHs configured through CGs, (2) PUSCHs in a same group as the UCI have priority for selection, (3) PUSCHs that include AP-CSI have priority for selection, (4) PUSCHs with lower CC indexes have priority for selection, and (5) PUSCHs with an earlier start time have priority for selection.

Aspect 8 is the apparatus of any of aspects 1-7, further includes that the rule order comprises (1) PUSCHs configured through DGs have priority for selection over PUSCHs configured through CGs, (2) PUSCHs that include AP-CSI have priority for selection, (3) PUSCHs in a same group as the UCI have priority for selection, (4) PUSCHs with lower CC indexes have priority for selection, and (5) PUSCHs with an earlier start time have priority for selection.

Aspect 9 is the apparatus of any of aspects 1-8, further includes that the rule order comprises (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs in a same group as the UCI have priority for selection, and (5) PUSCHs with an earlier start time have priority for selection.

Aspect 10 is the apparatus of any of aspects 1-9, further includes that the rule order comprises (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs with an earlier start time have priority for selection, and (5) PUSCHs in a same group as the UCI have priority for selection.

Aspect 11 is the apparatus of any of aspects 1-10, further includes that the selection of the one PUSCH is based at least partially on the one or more transmission parameters of each PUSCH of the plurality of PUSCHs, the one or more transmission parameters of each PUSCH of the plurality of PUSCHs comprises at least one of a starting RB index associated with a frequency domain resource allocation of the PUSCH, a MCS for the PUSCH, whether the PUSCH is an initial transmission or a retransmission, a resource allocation in time and frequency for the PUSCH, a number of layers in the PUSCH, a CG index of the PUSCH, whether the PUSCH has a same beam as a PUCCH resource on which the UCI was originally scheduled, or a transmission power associated with the PUSCH, wherein the selection of the one PUSCH is based at least partially on the one or more transmission parameters of the one PUSCH.

Aspect 12 is the apparatus of any of aspects 1-11, further includes that the selection of the one PUSCH for multiplexing the UCI is based on a rule order.

Aspect 13 is the apparatus of any of aspects 1-12, further includes that the rule order comprises (1) PUSCHs configured through DGs have priority for selection over PUSCHs configured through CGs, (2) PUSCHs that include AP-CSI have priority for selection, (3) PUSCHs with lower CC indexes have priority for selection, (4) PUSCHs with an earlier start time have priority for selection, and (5) the one or more transmission parameters.

Aspect 14 is the apparatus of any of aspects 1-13, further includes that when rule (5) is applied for selecting the one PUSCH for multiplexing the UCI after application of rules (1)-(4), the one PUSCH is selected based on at least one of whether the one PUSCH has a lowest starting RB index of the plurality of PUSCHs; whether the one PUSCH has a lowest MCS or a highest MCS of the plurality of PUSCHs; whether the one PUSCH corresponds to an initial transmission or a retransmission of the plurality of PUSCHs; whether the one PUSCH has a larger resource allocation in time and frequency of the plurality of PUSCHs; whether the one PUSCH has a larger number of layers or a smaller number of layers of the plurality of PUSCHs; whether the one PUSCH has a lower CG index of the plurality of PUSCHs; whether the one PUSCH is to be transmitted on a same beam as the PUCCH resource on which the UCI was originally scheduled; or whether the one PUSCH has a larger transmission power of the plurality of PUSCHs.

Aspect 15 is a method of wireless communication for implementing any of aspects 1-14.

Aspect 16 is an apparatus for wireless communication including means for implementing any of aspects 1-14.

Aspect 17 is a computer-readable medium storing computer executable code, where the code when executed by a processor causes the processor to implement any of aspects 1-14.

Aspect 18 is an apparatus for wireless communication at a UE including at least one processor coupled to a memory and configured to determine that a transmission of UCI would at least partially overlap in time with transmissions of a set of PUSCHs, the set of PUSCHs including a plurality of PUSCHs on a same CC that are at least partially overlapping in time; select at least one PUSCH of the set of PUSCHs for multiplexing the UCI, the at least one PUSCH including a different number of PUSCHs based on application of a rule order; and multiplex the UCI on each PUSCH of the selected at least one PUSCH for simultaneous transmission.

Aspect 19 is the apparatus of aspect 18, further including a transceiver coupled to the at least one processor.

Aspect 20 is the apparatus of any of aspects 18 and 19, further includes that the rule order comprises (1) PUSCHs configured through DGs have priority for selection over PUSCHs configured through CGs, (2) PUSCHs that include AP-CSI have priority for selection, (3) PUSCHs with lower CC indexes have priority for selection, and (4) PUSCHs with an earlier start time have priority for selection.

Aspect 21 is the apparatus of any of aspects 18-20, further includes that the at least one PUSCH comprises the plurality of PUSCHs when the plurality of PUSCHs have a same start time and, after application of rules (1)-(4), the plurality of PUSCHs remain for selection.

Aspect 22 is a method of wireless communication for implementing any of aspects 18-21.

Aspect 23 is an apparatus for wireless communication including means for implementing any of aspects 18-21.

Aspect 24 is a computer-readable medium storing computer executable code, where the code when executed by a processor causes the processor to implement any of aspects 18-21.

What is claimed is:

1. An apparatus for wireless communication at a user equipment (UE), comprising:
a memory; and
at least one processor coupled to the memory and configured to:
determine that a transmission of uplink control information (UCI) would at least partially overlap in time with transmissions of a set of physical uplink shared channels (PUSCHs), the set of PUSCHs including a plurality of PUSCHs on a same component carrier (CC) that are at least partially overlapping in time;
select one PUSCH of the set of PUSCHs for multiplexing the UCI, the selection of the one PUSCH being based at least partially on a group association between the UCI and each PUSCH of the set of PUSCHs, or one or more transmission parameters of each PUSCH of the plurality of PUSCHs; and
multiplex the UCI on the selected one PUSCH for simultaneous transmission.

2. The apparatus of claim 1, further comprising a transceiver coupled to the at least one processor.

3. The apparatus of claim 1, wherein the selection of the one PUSCH is based at least partially on the group association between the UCI and each PUSCH of the set of PUSCHs, and the selection of the one PUSCH is based at least partially on whether the one PUSCH is in a same group as the UCI.

4. The apparatus of claim 3, wherein each group is defined based on an association of the UCI and the PUSCH with at least one of a control resource set (CORESET) group, a UE panel identifier (ID), an uplink (UL) beam group, a sounding reference signal (SRS) resource set, a demodulation reference signal (DMRS) code division multiplex (CDM) group, or a priority.

5. The apparatus of claim 3, wherein the selection of the one PUSCH of the set of PUSCHs for multiplexing the UCI is based on a rule order.

6. The apparatus of claim 5, wherein the rule order comprises (1) PUSCHs in a same group as the UCI have priority for selection, (2) PUSCHs configured through dynamic grants (DGs) have priority for selection over PUSCHs configured through configured grants (CGs), (3) PUSCHs that include aperiodic (AP) channel state information (CSI) (AP-CSI) have priority for selection, (4) PUSCHs with lower CC indexes have priority for selection, and (5) PUSCHs with an earlier start time have priority for selection.

7. The apparatus of claim 5, wherein the rule order comprises (1) PUSCHs configured through dynamic grants (DGs) have priority for selection over PUSCHs configured through configured grants (CGs), (2) PUSCHs in a same group as the UCI have priority for selection, (3) PUSCHs that include aperiodic (AP) channel state information (CSI) (AP-CSI) have priority for selection, (4) PUSCHs with lower CC indexes have priority for selection, and (5) PUSCHs with an earlier start time have priority for selection.

8. The apparatus of claim 5, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs in a same group as the UCI have priority for selection, (4) PUSCHs with lower CC indexes have priority for selection, and (5) PUSCHs with an earlier start time have priority for selection.

9. The apparatus of claim 5, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, (4) PUSCHs in a same group as the UCI have priority for selection, and (5) PUSCHs with an earlier start time have priority for selection.

10. The apparatus of claim 5, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, (4) PUSCHs with an earlier start time have priority for selection, and (5) PUSCHs in a same group as the UCI have priority for selection.

11. The apparatus of claim 1, wherein the selection of the one PUSCH is based at least partially on the one or more transmission parameters of each PUSCH of the plurality of PUSCHs, the one or more transmission parameters of each PUSCH of the plurality of PUSCHs comprises at least one of a starting resource block (RB) index associated with a frequency domain resource allocation of the PUSCH, a modulation and coding scheme (MCS) for the PUSCH, whether the PUSCH is an initial transmission or a retransmission, a resource allocation in time and frequency for the PUSCH, a number of layers in the PUSCH, a configured grant (CG) index of the PUSCH, whether the PUSCH has a same beam as a physical uplink control channel (PUCCH) resource on which the UCI was originally scheduled, or a transmission power associated with the PUSCH, wherein the selection of the one PUSCH is based at least partially on the one or more transmission parameters of the one PUSCH.

12. The apparatus of claim 11, wherein the selection of the one PUSCH for multiplexing the UCI is based on a rule order.

13. The apparatus of claim 12, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, (4) PUSCHs with an earlier start time have priority for selection, and (5) the one or more transmission parameters.

14. The apparatus of claim 13, wherein when rule (5) is applied for selecting the one PUSCH for multiplexing the UCI after application of rules (1)-(4), the one PUSCH is selected based on at least one of:
whether the one PUSCH has a lowest starting RB index of the plurality of PUSCHs;
whether the one PUSCH has a lowest MCS or a highest MCS of the plurality of PUSCHs;
whether the one PUSCH corresponds to an initial transmission or a retransmission of the plurality of PUSCHs;
whether the one PUSCH has a larger resource allocation in time and frequency of the plurality of PUSCHs;
whether the one PUSCH has a larger number of layers or a smaller number of layers of the plurality of PUSCHs;
whether the one PUSCH has a lower CG index of the plurality of PUSCHs;
whether the one PUSCH is to be transmitted on a same beam as the PUCCH resource on which the UCI was originally scheduled; or
whether the one PUSCH has a larger transmission power of the plurality of PUSCHs.

15. A method of wireless communication at a user equipment (UE), comprising:
determining that a transmission of uplink control information (UCI) would at least partially overlap in time with transmissions of a set of physical uplink shared channels (PUSCHs), the set of PUSCHs including a plurality of PUSCHs on a same component carrier (CC) that are at least partially overlapping in time;
selecting one PUSCH of the set of PUSCHs for multiplexing the UCI, the selection of the one PUSCH being based at least partially on a group association between the UCI and each PUSCH of the set of PUSCHs, or one or more transmission parameters of each PUSCH of the plurality of PUSCHs; and
multiplexing the UCI on the selected one PUSCH for simultaneous transmission.

16. The method of claim 15, wherein the selection of the one PUSCH is based at least partially on the group association between the UCI and each PUSCH of the set of PUSCHs, and the selection of the one PUSCH is based at least partially on whether the one PUSCH is in a same group as the UCI.

17. The method of claim 16, wherein the selection of the one PUSCH of the set of PUSCHs for multiplexing the UCI is based on a rule order.

18. The method of claim 17, wherein the rule order comprises (1) PUSCHs in a same group as the UCI have priority for selection, (2) PUSCHs configured through dynamic grants (DGs) have priority for selection over PUSCHs configured through configured grants (CGs), (3) PUSCHs that include aperiodic (AP) channel state information (CSI) (AP-CSI) have priority for selection, (4) PUSCHs with lower CC indexes have priority for selection, and (5) PUSCHs with an earlier start time have priority for selection.

19. The method of claim 17, wherein the rule order comprises (1) PUSCHs configured through dynamic grants (DGs) have priority for selection over PUSCHs configured through configured grants (CGs), (2) PUSCHs in a same group as the UCI have priority for selection, (3) PUSCHs that include aperiodic (AP) channel state information (CSI) (AP-CSI) have priority for selection, (4) PUSCHs with lower CC indexes have priority for selection, and (5) PUSCHs with an earlier start time have priority for selection.

20. The method of claim 17, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs in a same group as the UCI have priority for selection, (4) PUSCHs with lower CC indexes have priority for selection, and (5) PUSCHs with an earlier start time have priority for selection.

21. The method of claim 17, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, (4) PUSCHs in a same group as the UCI have priority for selection, and (5) PUSCHs with an earlier start time have priority for selection.

22. The method of claim 17, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, (4) PUSCHs with an earlier start time have priority for selection, and (5) PUSCHs in a same group as the UCI have priority for selection.

23. The method of claim 15, wherein the selection of the one PUSCH is based at least partially on the one or more transmission parameters of each PUSCH of the plurality of PUSCHs, the one or more transmission parameters of each PUSCH of the plurality of PUSCHs comprises at least one of a starting resource block (RB) index associated with a frequency domain resource allocation of the PUSCH, a modulation and coding scheme (MCS) for the PUSCH, whether the PUSCH is an initial transmission or a retransmission, a resource allocation in time and frequency for the PUSCH, a number of layers in the PUSCH, a configured grant (CG) index of the PUSCH, whether the PUSCH has a same beam as a physical uplink control channel (PUCCH) resource on which the UCI was originally scheduled, or a transmission power associated with the PUSCH, wherein the selection of the one PUSCH is based at least partially on the one or more transmission parameters of the one PUSCH.

24. An apparatus for wireless communication at a user equipment (UE), comprising:
a memory; and
at least one processor coupled to the memory and configured to:
determine that a transmission of uplink control information (UCI) would at least partially overlap in time with transmissions of a set of physical uplink shared channels (PUSCHs), the set of PUSCHs including a plurality of PUSCHs on a same component carrier (CC) that are at least partially overlapping in time;
select at least one PUSCH of the set of PUSCHs for multiplexing the UCI, the at least one PUSCH including a different number of PUSCHs based on application of a rule order; and
multiplex the UCI on each PUSCH of the selected at least one PUSCH for simultaneous transmission.

25. The apparatus of claim 24, further comprising a transceiver coupled to the at least one processor.

26. The apparatus of claim 24, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, and (4) PUSCHs with an earlier start time have priority for selection.

27. The apparatus of claim 26, wherein the at least one PUSCH comprises the plurality of PUSCHs when the plurality of PUSCHs have a same start time and, after application of rules (1)-(4), the plurality of PUSCHs remain for selection.

28. A method of wireless communication at a user equipment (UE), comprising:
determining that a transmission of uplink control information (UCI) would at least partially overlap in time with transmissions of a set of physical uplink shared channels (PUSCHs), the set of PUSCHs including a plurality of PUSCHs on a same component carrier (CC) that are at least partially overlapping in time;
selecting at least one PUSCH of the set of PUSCHs for multiplexing the UCI, the at least one PUSCH including a different number of PUSCHs based on application of a rule order; and
multiplexing the UCI on each PUSCH of the selected at least one PUSCH for simultaneous transmission.

29. The method of claim 28, wherein the rule order comprises (1) PUSCHs configured through dynamic grants (DGs) have priority for selection over PUSCHs configured through configured grants (CGs), (2) PUSCHs that include aperiodic (AP) channel state information (CSI) (AP-CSI) have priority for selection, (3) PUSCHs with lower CC indexes have priority for selection, and (4) PUSCHs with an earlier start time have priority for selection.

30. The method of claim 29, wherein the at least one PUSCH comprises the plurality of PUSCHs when the plurality of PUSCHs have a same start time and, after application of rules (1)-(4), the plurality of PUSCHs remain for selection.
